(19) United States
(12) Patent Application Publication
(10) Pub. No.: US 2009/0019424 A1
(43) Pub. Date: Jan. 15, 2009

(54) SYSTEM AND METHOD OF APPLICATION CONTEXT DRIVEN ACCESS RESTRICTION

(75) Inventors: Udo Klein, Maximiliansau (DE); Frank Brunswig, Heidelberg (DE)

Correspondence Address: KENYON & KENYON LLP, ONE BROADWAY, NEW YORK, NY, 10004, US

(73) Assignee: SAP AG, Walldorf (DE)

(21) Appl. No.: 11/776,984

(22) Filed: Jul. 12, 2007

(51) Int. Cl. G06F 13/14; G06F 9/44

(52) U.S. Cl. 717/116; 719/315

(57) ABSTRACT

A method and system for providing application context restrictions are provided. The method may include, responsive to a request from a first object to a second object, comparing an application context of the first object with an application context of the second object. The method may include, if the comparison succeeds as determined by predefined rules, allowing a response from the second object to be transmitted to the first object. The method may include, if the comparison fails as determined by predefined rules, restricting the response from the second object to the first object.

### BACKGROUND

In a business application with interactions between multiple software objects and users, restricted data may unintentionally be leaked to a user through user message channels. For example, a first object may call a method in a second object. The second object may throw an error message, which is passed back to the first object. The first object may not be programmed to handle error message from other objects, and may simply display the error message. This may result in sensitive information being displayed if the error message is not related to the called method, but rather displays an inconsistent object state. This inconsistency may include sensitive information such as credit card information or social security numbers.

Available runtime authorization checks based on user restrictions involve messages to the user which are first checked against a user's access level before being displayed. However, user-based restrictions may be cumbersome to implement and maintain in a system with a large number of users.

A need exists to allow an object to access only information relevant to a call. Information received from a call may include errors, warnings, information, or success messages. This is true with regards to objects that are capable of inconsistent internal states.

### BRIEF DESCRIPTION OF THE DRAWINGS

FIG. 1 depicts an example system for providing application context driven access restrictions in accordance with an embodiment of the present invention.

FIG. 2 depicts an example data structure for a business object with an assigned application context in accordance with an embodiment of the present invention.

FIG. 3 depicts an example procedure for checking an application context of a business object at runtime in accordance with an embodiment of the present invention.

FIG. 4 depicts an example data structure for storing a hierarchy of application contexts in accordance with an embodiment of the present invention.

FIG. 5 depicts an example procedure for comparing a first application context and a second application context in accordance with an embodiment of the present invention.

FIG. 6 depicts an example initialization procedure in accordance with an embodiment of the present invention.

### DETAILED DESCRIPTION

A method and system are provided to provide application context driven access restrictions. Applications, objects, and information associated with objects are grouped in suitable “application contexts.” When information is received from an object in response to a call, the receiving object verifies that the information is associated with an appropriate application context. If an appropriate application context is found, the information is allowed to pass. If an appropriate application context is not found, the unauthorized information is wiped and/or removed and/or replaced before the information is allowed to pass. A substitute or generic message may replace the unauthorized information.

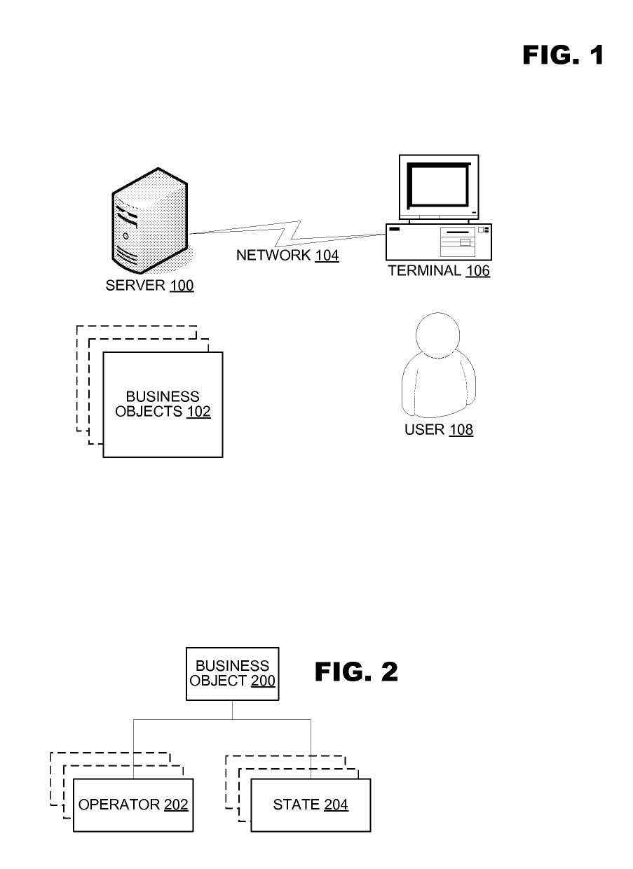

FIG. 1 depicts an example system for providing application context driven access restrictions in accordance with an embodiment of the present invention. The system may include a server 100 and a terminal 106 in communication over a network 104. The server 100 may be geographically remote from the terminal 106.

The server 100 may include a plurality of business objects 102. For example, the business objects 102 may be stored on a rewritable medium accessible to the server 100. The business objects 102 may be used in programming the server 100 to provide a software environment over the system. The business objects 102 also may be as described below.

The terminal 106 may provide a user interface to a user 108. The terminal 106 may provide the user 108 access to the server 100 in creating and modifying business objects 102.

FIG. 2 depicts an example data structure for a business object with an assigned application context in accordance with an embodiment of the present invention. The business object may be an object as understood in the art of, for example, object-oriented programming. Each business object 200 may include one or more operators 202. Each operator may be configured to act on the business object 200. An operator may be a method as known in the art of object-oriented programming.

Each business object 200 may include one or more states 204. Each state 204 may store information relevant to the business object 200. The operator 202 may be configured to read, modify, or delete the state 204.

An application context of the business object 200 may be stored as a state 204. All parts of the business object 200 may be assigned one or more application contexts. Furthermore, individual states 204 of the business object 200 may be assigned application contexts. For example, a business object 200 may be an employee record. The employee record may include states “Name” and “Personal Information.” While “Name” may be associated with a plurality of application contexts, “Personal Information” may be only associated with a “Confidential” application context.

In an alternative embodiment, the system may maintain a lookup table associating every entity within the system with an appropriate application context. Entities may be objects, variables, etc. within the system. The lookup table may be stored as one or more arrays, objects, tree, or other data structures.

Application contexts may be selected to provide a desired level of granularity. For example, a set of available applications within a system may be expressed as an application context tree. For example, applications may include HCM, FIN, CRM, etc. Certain applications may be included within a main application context. Within each application, functionality may also be associated with an application context, for example, hiring, accounting, customer service, etc.

Application contexts, in combination with verification routines described below, will ensure that the “Personal Information” is not unintentionally displayed in an error message.

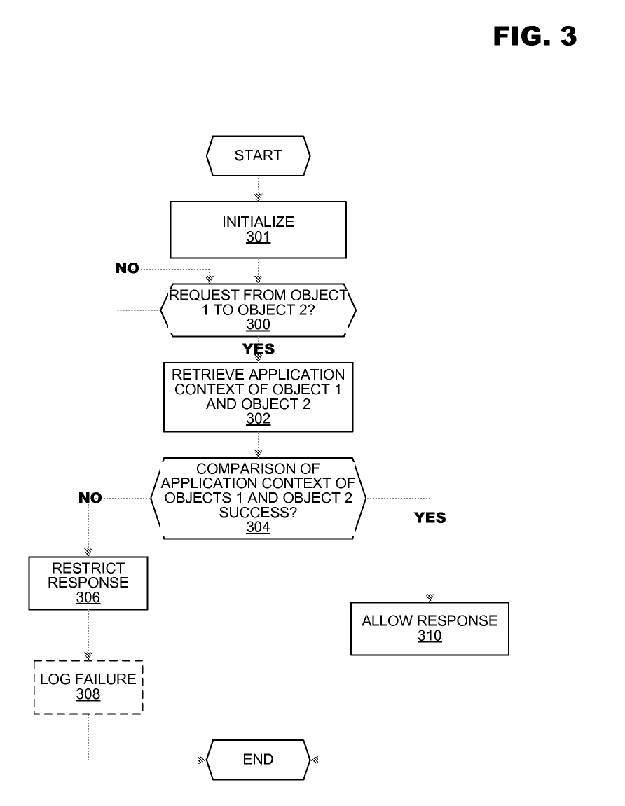

FIG. 3 depicts an example procedure for checking an application context of a business object at runtime in accordance with an embodiment of the present invention. The procedure may execute on a server in a system as depicted in FIG. 1 and utilize business objects as depicted in FIG. 2.

Each business object used in the system is assigned an application context. For example, application contexts may have specific business-related meanings such as “Human Capital Management”, “Time and Labor Management”, or “Customer Relationship Management.”

Application contexts may be nested, for example, “Time and Labor Management” may be a part of “Human Capital Management.” The application context of a first business object is checked before it receives a response from called method of a second business object. Each business object may be associated with one or more application contexts.

For example, application contexts may be set by a programmer as design time of the business objects. In an alternatively, application contexts may be set by an executing program at run time.

In 300, the server may detect a request from a first object to a second object. The request may be the first object attempting to invoke a method of the second object. The request may result in a response being generated at the second object to be transmitted back to the first object.

The generated response may be a response object and further associated with an application context, similar to the objects. The response may be a response object, which includes the response application context. The response may be a string, and is associated with the response application context through a system lookup table as described above.

In 301, an initialization procedure may be called. For example, the initialization procedure may be as depicted in FIG. 6.

In 302, the server may retrieve application contexts of the first and the second objects. For example, the application context may be associated with the objects in server-accessible memory or another manner.

The application contexts may be assigned at design-time, when a programmer defines objects in the system.

In 304, the server may compare the application contexts of the first and the second objects in accordance with predefined rules. For example, application contexts may be organized into hierarchies, and access may be allowed for all children application contexts to a parent application context. Alternatively, access may only be allowed if the application contexts match.

Furthermore, the server may compare the application contexts of the response and the first object, if the response is associated with an application context.

If access is to be allowed, the procedure proceeds to 310. If access is to be disallowed, the procedure proceeds to 306.

In 306, the system may restrict the response. For example, the system may replace messages in the response including confidential information with generic messages. Alternatively, the response may be stopped and an error message sent to the first object. Alternatively, the response may be stopped and nothing is sent to the first object. Possible outcomes when restricting the response may be stored in a lookup table accessible to the system.

In 308, the system optionally logs a comparison failure in 304. The log may be used by administrators for audit purposes.

In 310, the system may allow the response from the second object to be passed to the first object.

It should be appreciated that the concept of application contexts may be applied to more than objects within a system. For example, applications executing on the system may each be associated with an application context, which are checked when applications attempt to interact with other applications.

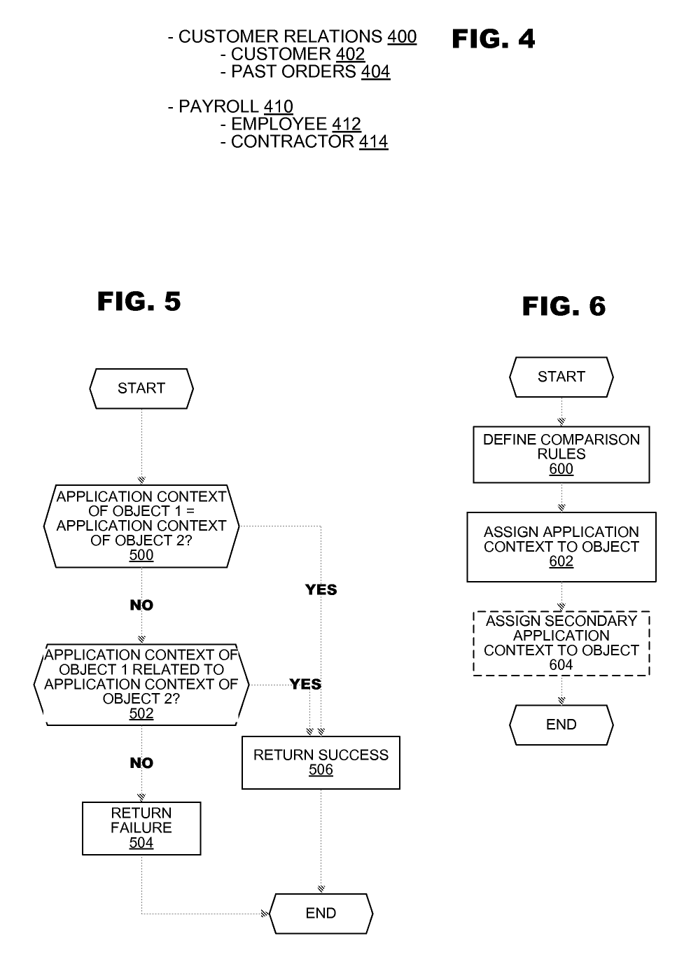

FIG. 4 depicts an example data structure for storing a hierarchy of application contexts in accordance with an embodiment of the present invention. The data structure may store a plurality of primary application contexts, such as customer relations 400 and payroll 410. Each application context may include sub-application contexts. For example, customer relations 400 includes customer 402 and past orders 404. Similarly, payroll 410 includes employee 412 and contractor 414. The application contexts may be compared as described below.

FIG. 5 depicts an example procedure for comparing a first application context and a second application context in accordance with an embodiment of the present invention. The comparison procedure may be called from a procedure as depicted in FIG. 3. The application contexts may be hierarchical in nature, and every child application context is allowed access to all sibling application contexts and parent application contexts.

In 500, the procedure tests if an application context of a first object is equal to an application context of a second object. If yes, the comparison succeeds and the procedure proceeds to 506, where success is returned. If no, the procedure proceeds to 502.

In 502, the procedure tests if the application context of the first object is related to the application context of the second object. For example, sibling application contexts may be allowed access to each other, and child application contexts may be allowed access to parent application contexts. However, parent application contexts may not be allowed access to children application contexts. If yes, the comparison succeeds and the procedure proceeds to 506, where success is returned. If no, the procedure proceeds to 504, where failure is returned.

It should be appreciated that the rules of relating application contexts may be set by the programmer at design time and/or dynamically modified at run time.

FIG. 6 depicts an example initialization procedure in accordance with an embodiment of the present invention. The initialization procedure may be called from a procedure such as the example procedure depicted in FIG. 3.

In 600, a set of comparison rules may be defined for a plurality of application contexts. For example, application contexts may be in a hierarchical structure, as described above. The comparison rules may be defined at design time or modified at run time.

In 602, application contexts may be assigned to an object in the system, for example, as described above. In 604, the procedure may optionally assign secondary application contexts to the object of 602. An object may be associated with one or more application contexts.

It should be understood that application contexts may be assigned to each object within the system.

An example embodiment of the present invention may be a method for allowing response transmissions. The method may include defining a set of comparison rules for a plurality of application contexts. The method may include, responsive to a request from a first software object to a second software object, comparing an application context of the first software object with an application context of the second software object. The method may include, if the comparison succeeds as determined by the comparison rules, allowing a response from the second software object to be transmitted to the first software object. The method may include, if the comparison fails as determined by the comparison rules, restricting the response from the second software object to the first software object. The method may include assigning the application context of the first software object and the application context of the second software object at design time. The first software object and the second software object may be each assigned a plurality of application contexts. The request may include the first software object invoking a method of the second software object. The response may be restricted by replacing a message in the response with a replacement message, the selected message having triggered the comparison failure. The response may be a response object associated with an application context, and the response object application context is compared with the application context of the first software object. The method may include, if the comparison fails as determined by comparison rules, logging the failure in a persistent medium.

Another example embodiment of the present invention may be a system for allowing response transmissions. The system may include a memory storing a first software object and a second software object, wherein the first object is associated with a first application context and the second object is associated with a second application context. The system may include a server in communication with the memory, the server configured to define a set of comparison rules for a plurality of application contexts. The server may be configured to, responsive to a request from the first software object to the second software object, comparing an application context of the first software object with an application context of the second software object. The server may be configured to, if the comparison succeeds as determined by the comparison rules, allow a response from the second software object to be transmitted to the first software object. The server may be configured to, if the comparison fails as determined by the comparison rules, restrict the response from the second software object to the first software object. The server may be configured to assign the application context of the first software object and the application context of the second software object at design time. The first software object and the second software object may be each assigned a plurality of application contexts. The request may include the first software object invoking a method of the second software object. The response may be restricted by replacing a message in the response with a replacement message, the selected message having triggered the comparison failure. The response may be a response object associated with an application context, and the response object application context is compared with the application context of the first software object. The server may be configured to, if the comparison fails as determined by comparison rules, logging the failure in a persistent medium.

Another example embodiment of the present invention may be a computer-readable medium including instructions adapted to execute a method for allowing response transmissions. The method may include defining a set of comparison rules for a plurality of application contexts. The method may include responsive to a request from a first software object to a second software object, comparing an application context of the first software object with an application context of the second software object. The method may include, if the comparison succeeds as determined by the comparison rules, allowing a response from the second software object to be transmitted to the first software object. The method may include if the comparison fails as determined by the comparison rules, restricting the response from the second software object to the first software object. The method may include assigning the application context of the first software object and the application context of the second software object at design time. The first software object and the second software object may be each assigned a plurality of application contexts. The request may include the first software object invoking a method of the second software object. The response may be restricted by replacing a message in the response with a replacement message, the selected message having triggered the comparison failure. The response may be a response object associated with an application context, and the response object application context is compared with the application context of the first software object. The method may include, if the comparison fails as determined by comparison rules, logging the failure in a persistent medium.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should be understood that there exist implementations of other variations and modifications of the invention and its various aspects, as may be readily apparent to those of ordinary skill in the art, and that the invention is not limited by specific embodiments described herein. Features and embodiments described above may be combined with each other in various ways providing further embodiments. It is therefore contemplated to cover any and all modifications, variations, combinations or equivalents that fall within the scope of the basic underlying principals disclosed and claimed herein.

What is claimed is:

1. A method for allowing response transmissions, comprising:
defining a set of comparison rules for a plurality of application contexts;
responsive to a request from a first software object to a second software object, comparing an application context of the first software object with an application context of the second software object;
if the comparison succeeds as determined by the comparison rules, allowing a response from the second software object to be transmitted to the first software object; and
if the comparison fails as determined by the comparison rules, restricting the response from the second software object to the first software object.

2. The method of claim 1, further comprising:
assigning the application context of the first software object and the application context of the second software object at design time.

3. The method of claim 2, wherein the first software object and the second software object are each assigned a plurality of application contexts.

4. The method of claim 1, wherein the request includes the first software object invoking a method of the second software object.

5. The method of claim 4, wherein the response is restricted by replacing a message in the response with a replacement message, the selected message having triggered the comparison failure.

6. The method of claim 1, wherein the response is a response object associated with an application context, and the response object application context is compared with the application context of the first software object.

7. The method of claim 1, further comprising:
if the comparison fails as determined by comparison rules, logging the failure in a persistent medium.

8. A system for allowing response transmissions, comprising:
a memory storing a first software object and a second software object, wherein the first object is associated with a first application context and the second object is associated with a second application context; and
a server in communication with the memory, the server configured to,
define a set of comparison rules for a plurality of application contexts,
responsive to a request from the first software object to the second software object, comparing an application context of the first software object with an application context of the second software object,
if the comparison succeeds as determined by the comparison rules, allow a response from the second software object to be transmitted to the first software object, and
if the comparison fails as determined by the comparison rules, restrict the response from the second software object to the first software object.

9. The system of claim 8, the server further configured to,
assign the application context of the first software object and the application context of the second software object at design time.

10. The system of claim 9, wherein the first software object and the second software object are each assigned a plurality of application contexts.

11. The system of claim 8, wherein the request includes the first software object invoking a method of the second software object.

12. The system of claim 11, wherein the response is restricted by replacing a message in the response with a replacement message, the selected message having triggered the comparison failure.

13. The system of claim 8, wherein the response is a response object associated with an application context, and the response object application context is compared with the application context of the first software object.

14. The system of claim 8, the server further configured to,
if the comparison fails as determined by comparison rules, log the failure in a persistent medium.

15. A computer-readable medium including instructions adapted to execute a method for allowing response transmissions, the method including,
defining a set of comparison rules for a plurality of application contexts;
responsive to a request from a first software object to a second software object, comparing an application context of the first software object with an application context of the second software object;
if the comparison succeeds as determined by the comparison rules, allowing a response from the second software object to be transmitted to the first software object; and
if the comparison fails as determined by the comparison rules, restricting the response from the second software object to the first software object.

16. The medium of claim 15, the method further including,
assigning the application context of the first software object and the application context of the second software object at design time.

17. The medium of claim 16, wherein the first software object and the second software object are each assigned a plurality of application contexts.

18. The medium of claim 15, wherein the request includes the first software object invoking a method of the second software object.

19. The medium of claim 18, wherein the response is restricted by replacing a message in the response with a replacement message, the selected message having triggered the comparison failure.

20. The medium of claim 15, wherein the response is a response object associated with an application context, and the response object application context is compared with the application context of the first software object.
